(19) United States
(12) Patent Application Publication
(10) Pub. No.: US 2022/0048076 A1
(43) Pub. Date: Feb. 17, 2022

(54) SYSTEM AND METHOD FOR MONITORING A SCREENING MACHINE

(71) Applicant: Allgaier Werke Gmbh, Uhingen (DE)

(72) Inventor: Mathias Trojosky, Kirchheim unter Teck (DE)

(21) Appl. No.: 17/293,246

(22) PCT Filed: Nov. 20, 2019
(86) PCT No.: PCT/EP2019/081874

§ 371 Date: May 12, 2021

(30) Foreign Application Priority Data
Nov. 29, 2018 (EP) 18209076.1

(51) Int. Cl. B07B 13/14; G01N 29/14; G01N 29/44; B07B 1/28; B07B 1/46

(52) U.S. Cl. CPC B07B 13/14; G01N 29/14; G01N 29/4481; G01N 2291/0289; B07B 1/288; B07B 1/4609; G01N 29/4454

(57) ABSTRACT

There is provided a system for monitoring a screening machine, comprising a vibration sensor configured to record a vibration response of a screen fabric of the screening machine; and a signal processing device for digitally processing and evaluating the vibration response. In this connection, the signal processing device comprises an adaptive algorithm which is based on the methods of artificial intelligence, is related to vibration responses of one or several comparative screen fabrics and is adapted to characterize the vibration response recorded by the vibration sensor. Furthermore, a method for monitoring a screening machine is presented.

The subject matter of the present invention is a system as well as a method for monitoring a screening machine.

From prior art there are known various devices and methods for monitoring screening machines. In different industrial fields, the monitoring of the quality-assuring functioning of screening machines is an imperative requirement. Over and over again, serious breakdowns, damages or losses occur due to defective screen fabrics in screening machines. A quite often large amount of bulk solids of a coarser grain size and not conforming to specifications gets into the fine fraction because of an undetected tear of the screen fabric.

When a screen tear is discovered only late, a correspondingly large amount of solid material has to be dumped or, after repair of the screen fabric, has to be transported once again over the screening machine. If a possibly extremely fine damage of a screen fabric is not detected at all, the distribution and delivery of faulty material and the potential further processing thereof at the end customer can lead to a considerable consequential damage in the further processing combined with a contaminated or faulty end product.

Therefore, there exist various technologies, i.e., devices and methods, for detecting, at an early stage, tears, ruptures or other defects in a screen fabric as well as contaminations of screened products resulting therefrom. Apart from indirect methods for detecting screen tears in which the flow of fine material running through the screen is monitored and in which by means of different methods the occurrence of coarse particles not conforming to specifications is checked, for this task also direct measuring methods are employed which are based on the monitoring of the screen fabric itself and of its intactness and integrity.

From patent specification DE 10154816 B4 there is known an indirect method in which the screened fine material is directed onto an oscillating body which, preferably, is located in an outlet of a screening machine. The aim is to electronically record and evaluate the vibrations or sound waves excited by the impact of particles on the oscillating body. In case of a screen tear, the coarse particles contained in the fine material would generate a sound pattern deviating from the normal state, wherein said sound pattern will be recorded and evaluated by a sensitive electronic system. Said system is no direct measuring method at the screen fabric, but only analyses the screened product. By said system no complete analysis of the entire screened amount of solid material can be carried out, as the expenditure of analysis therefor would be too high. As only a part of the screened amount of solid material is analyzed, the analysis result is fraught with a corresponding statistical uncertainty.

Furthermore, optoelectronic systems as presented at the trade fairs PowTech 2011 and PowTech 2016 are known which permanently monitor the flow of screened fine material by means of optoelectronic devices. In so doing, deviations from a preset grain spectrum can be recognized and evaluated electronically. Said systems, however, also only evaluate a small sample quantity of the entire flow of solid material, and, as indirectly acting systems, they are also fraught with a corresponding statistical uncertainty.

From patent specifications EP 2 340 130 B1 and U.S. Pat. No. 8,607,988 B2 there is known a screening machine in which a screen fabric of synthetic material is at least partially provided with an electrically conductive layer in the form of tracks traversing the screening area. By means of a voltage applied to these conductive tracks, or a current impressed to said conductive tracks, a screen tear is detected in such a way that in case of a screen tear the current flow is interrupted and a change of voltage or current is detectable. By its very nature, said system is not suitable for electrically conductive screen feed—as for instance metallic powder—or for an electrically conductive—for instance metallic—screen fabric.

Furthermore, from patent specification DE 4324066 C2 there is known a system in which a screen fabric is implemented by means of two different materials, namely in a first direction by electrically conductive wire threads, in particular warp threads, and in a second direction by electrically non-conducting synthetic threads, so-called weft threads. A voltage is applied to expanded parallel electrodes on both sides of the screen fabric, between which the electrically conductive wire threads run in parallel to each other, so that a measurable, in particular sudden change in current through the screen fabric is detectable if one or several of these wire treads will tear or break. A break of the non-conducting synthetic threads in the second direction of the screen fabric cannot be detected. Instead of electrically conductive wire threads there are also mentioned optical fibers or hollow threads to which there is applied a material flow or a pressure or light and which can also indicate a break.

A similar technical solution is known from patent application EP 1 806 185 A1 which also comprises conductive tracks of which a screen fabric is made.

Another technical solution is known from patent specifications U.S. Pat. No. 7,516,851 B2 and EP 1 603 687 B1, wherein electromagnetic waves in the radio frequency range are used. Here, a transmitter and a receiver are attached above and below the screen, respectively. In case of a screen tear, electromagnetic waves in the radio frequency range pass through the screen and can be picked up and evaluated by the receiver.

A similar technical solution is known which uses microwaves. Here, the transmitter and the receiver do not work in the radio frequency range, but in the microwave range. What is required is a design of the entire screening machine which is resistant and sealed against microwaves. Furthermore, due to the applied microwave energy, screen feeds in dust or powder form with a low ignition energy are subject to a quite considerable risk of explosion.

From patent application JP H11-290781 A there is known a screening machine in which, at an ultrasonic generator impressing an ultrasonic wave to the screen fabric, the current curve and the voltage curve are continuously monitored and evaluated with regard to amplitude and phase. In case of a screen tear, a change of the phase displacement between current and voltage and, thus, a changed consumption of apparent power of the ultrasonic generator is detected by an electronic phase sensor and evaluated by means of electronic devices. The change in the consumption of apparent power caused by a screen tear is, however, very small and heavily overlaid by other effects, which makes a reliable evaluation quite difficult.

From utility model JP H04-046867 Y there is known a device for detecting a screen tear, wherein said device records and recognizes a high-frequency tearing noise—which is generated by the tearing of the screen—by means of a high-frequency sound sensor or an ultrasonic microphone arranged near the screen. Said effect is very small and of short duration, and it is difficult to distinguish it from strong, other noises, as for instance the noise of the screen feed during screening, so that also in case of this solution a reliable detection of a screen tear is substantially hampered.

From patent application JP 2008-224261 A there is known a rupture detecting method for screens and screening machines, in which an acoustic sensor is attached at the screening device. The sensor records an acoustic signal which is generated by the contact between screen feed and screen netting during normal operation with an intact screen netting, and, moreover, it also recognizes an additional acoustic signal which is generated in case of a screen rupture by the rupture fragments. The recorded signal will be compared with already preset reference values, and, on the basis thereof, a rupture detection is determined. Also, in this solution, other effects, as for instance varying properties of the screen feed and a change of the recorded acoustic signal caused thereby, interfere quite enormously with the reliability and reproducibility of the detection of a screen rupture. This is in particular due to the fact that the preset reference value only works sufficiently well for a certain configuration of the screen fabric as well as for the respectively currently given operating state of the screening machine.

Thus, the invention has the object to provide a device and a method by means of which the disadvantages of prior art, in particular with regard to the monitoring of screening machines, can be overcome. Said object is solved by the inventive system with the features according to claim 1, by the screening machine according to claim 13, by the method with the features according to claim 15, as well as by the computer program with the features according to claim 19. Advantageous further developments of the present invention are indicated in the dependent claims 2 to 12, 14, and 16 to 18.

The inventive system for monitoring a screening machine comprises a vibration sensor configured to record a vibration response of a screen fabric of the screening machine; and a signal processing device for digitally processing and evaluating the vibration response. In this connection, the signal processing device comprises an adaptive algorithm which is based on the methods of artificial intelligence, is related to vibration responses of one or several comparative screen fabrics and is adapted to characterize the vibration response recorded by the vibration sensor.

The one or several comparative screen fabrics can comprise the screen fabric of the screening machine to be monitored and/or other screen fabrics.

The vibration response is related to a vibration impressed to the screen fabric of the screening machine to be monitored. It is advantageous if the inventive system for monitoring the screening machine comprises an excitation device which is configured to impress the vibration to the screen fabric of the screening machine. The vibration response indicates the reaction of the screen fabric to the impressed vibration. Therefore, the vibration response is an indicator for influences of any kind onto the screen fabric. In particular it is possible to detect defects in the screen fabric, as for instance tears or ruptures, abrasion, extensions, blindings or cloggings, or mesh expansions, by evaluating or analyzing the vibration response. The vibration response can be dependent on various factors, like for instance the geometry, the material, and the structure of the screen fabric. Furthermore, changes in the screen fabric, e.g., a developed tear, lead to changed vibration responses. These can be attributed to reflection and/or diffraction effects of the impressed vibration at imperfections of the screen fabric. Also, the crackling of bulk solids onto the screen fabric affects the vibration response. Consequently, changes in the vibration responses illustrate in a characteristic manner the changed state of the screen fabric, for instance by a displacement of its frequency spectrum or by changes in the amplitude in one area of or generally in several areas of the frequency spectrum.

According to the invention, the adaptive algorithm is based on methods of artificial intelligence (AI). Artificial intelligence is a branch of computer sciences with the aim to enable machines to autonomously solve tasks with an optimum result.

The advantage of an adaptive algorithm for the characterization of vibration responses—which is related to vibration responses of one or several comparative screen fabrics—is, among other things, that defects, for instance tears, of the screen fabric of the screening machine to be monitored can be reliably detected. Furthermore, the system itself can independently adjust to various screen arrangements, screen types with different properties, various screen geometries and screen fabrics. Even slowly proceeding, continuous changes in the screen fabric properties due to normal wear of the screen fabric, also prior to the development of a distinct defect, can be systematically characterized by a constant learning of the system. Among other things, this opens up the possibility of the so-called predictive maintenance. Moreover, here an additional readjustment is not necessary despite the changing properties of the screen fabric, as this is performed autonomously by the adaptive system.

It is particularly preferred that the adaptive algorithm is related to vibration responses of a plurality of comparative screen fabrics. Thereby the adaptive system can adjust itself to a large number or variety of screen arrangements, screen types, screen geometries, screen fabrics and their (varying) properties.

Hence, the system according to the invention has the advantage that the characterization and detection of vibration responses can be implemented as a direct measuring method at the screen fabric. In contrast to methods hitherto known, the characterization and the detection of defects in the screen fabric do not have to be carried out by the static indication of detection criteria, but said criteria can be learned autonomously and can optimize themselves continuously. Finally, thereby the operational life of a screening machine can be increased, a higher process security during fractioning can be enabled, and the maintenance expenditure can be minimized by the constantly improving error detection of the system.

It is particularly preferred that the characterization of the recorded vibration response is performed with the aid of error signatures which are characteristic for deviations of the recorded vibration responses between a normal state of the screen fabric and an error state of the screen fabric. The normal state characterizes the screen fabric having no defect, and the error state characterizes the screen fabric having a defect. Thus, error signatures are appropriate indicators for changes in the screen fabric. It is expedient if the error signatures are determined by the inventive system itself or by the inventive adaptive algorithm itself.

Expediently, the adaptive algorithm is based on machine learning. Machine learning is a method of artificial intelligence. Machine learning is configured to learn autonomously in order to thus independently determine patterns or regularities of recorded vibration responses, even if these are quite complex, overlaid or changed by external interfering influences.

Advantageously, the adaptive algorithm comprises an artificial neural network. This is a special form of machine learning which can acquire a certain behavior by training. In the following, by way of example two possible forms of training will be described. Further forms of training will be described further below.

It is particularly preferred that vibration responses of the comparative screen fabrics are input as input data into the algorithm, so that therefrom the algorithm can determine regularities either with or without any additional input of preset target values. Target values are for instance previously characterized vibration responses of certain states of the screen fabric. Target values can for instance be vibration responses of defective or intact screen fabrics; however, according to the invention also a classification into further states or classes of states is possible. When preset target values are taken into account, then the adaptive algorithm determines, with the aid of data pairs comprising input data and corresponding target values, first of all identification criteria which subsequently allow the adaptive algorithm to characterize a vibration response recorded at the screening machine to be monitored. This is the so-called training of the algorithm. In other words, the identification criteria are advantageously determined such that an optimum prediction of the state of the screen fabric on the basis of the data pairs consisting of input data/target values can be made. Preferably, in this case comparative screen fabrics can be deployed which are different from the screen fabric of the screening machine to be monitored. Advantageously, the comparative screen fabrics are at first similar to the screen fabric of the screening machine to be monitored and later are partially or substantially different therefrom.

Instead of using preset target values, it is also possible that the algorithm performs a classification of the vibration responses by means of patterns or regularities in recorded vibration responses of the screen fabric of the screening machine to be monitored. In this case, the comparative screen fabric is the screen fabric of the screening machine to be monitored. The vibration responses will expediently be classified into defective screen fabrics and intact screen fabrics; according to the invention, however, also further classes are possible. When vibration responses originating from screen fabrics having defects and vibration responses originating from intact screen fabrics are input into the adaptive algorithm and are compared by said algorithm, the algorithm can recognize autonomously patterns or regularities in the vibration responses. The patterns or regularities allow for a classification into different states of the screen fabric. With each further characterization of an input vibration response, the algorithm can continue learning, i.e. it will be trained. Progressive training of the adaptive algorithm with further vibration responses characterizing screen fabrics having defects or not having defects enable the algorithm to classify different states of the screen fabric of the screening machine to be monitored in an increasingly precise manner. Accordingly, through an extensive training recorded vibration responses can be characterized in a differentiated manner and, thus, a high variety of different states of the screen fabric can be generated. It can, however, also be expedient to deliberately keep the amount of states of the screen fabric strictly limited by a purposeful training. This is particularly practical if the number of the different states of the screen fabric shall be low and if few differently classified vibration responses will be sufficient. Furthermore, said purposeful training of the adaptive algorithm can lead to a shorter time of training than an extensive training.

By means of a purposeful training, with the algorithm it is also possible to adapt to changing interfering influences (side noises of machines in the surroundings of the screen fabric, damping, temperature variations, passing cars, possible service work, etc.) in the recorded vibration responses, which otherwise interfere with and mask error signatures. Thus, the training of the algorithm can be carried out decidedly by the characterization of vibration responses which are affected by interfering influences.

Preferably, the comparative screen fabrics comprise screen fabrics which are different from the screen fabric of the screening machine to be monitored. Thereby, in an advanced learning phase of the adaptive algorithm, states of screen fabrics to be monitored can be characterized beforehand so that the detection of defective screen fabrics by the adaptive algorithm will become also possible for hitherto unknown or not specially trained screen fabrics and operating conditions. Furthermore, after including all vibration responses of the comparative screen fabrics, it is also possible to continue the training by the further characterization of the vibration responses recorded by the vibration sensor, in order to increase the amount of the different states of the screen fabric, or to conclude the training in order to reduce the training time to one new screen fabric or to a new operating state. Preferably, the training time amounts to not more than a few minutes. Said configuration is particularly favorable for the so-called supervised learning or for the so-called semi-supervised learning of the adaptive algorithm. These two forms of learning will be described in detail in the following.

Advantageously, the adaptive algorithm is based on supervised learning. Supervised learning is a special form of machine learning. It is advantageous to characterize vibration responses by an adaptive algorithm which is based on supervised learning.

When the adaptive algorithm is based on supervised learning, the recorded vibration response will for instance be compared with known error signatures of one or several comparative screen fabrics. In the supervised learning, the comparative screen fabrics advantageously differ from the screen fabric of the screening machine to be monitored. In case of deviations between the recorded vibration response and the known error signatures, the algorithm can characterize a defect as such on the basis of the learned error signatures.

In case of a combination of an artificial neural network and the supervised learning, the training of the algorithm is carried out prior to the start-up of the screening machine to be monitored. The algorithm is preferably trained by the fact that vibration responses of the comparative screen fabrics are input into the algorithm together with a corresponding classification. In other words: vibration responses belonging to different configurations of the screen fabric will be provided to the algorithm together with the corresponding state of the screen fabric. Configurations or states of the screen fabric can be: a certain size of an intact screen fabric; a certain size of a defective screen fabric with bulk solids crackling thereon; a certain mesh size of a defective screen fabric with the position of a tear; etc. From the predefined configurations with the corresponding states of the screen fabric the algorithm can determine identification criteria by means of which the algorithm will identify the state of a screen fabric from an unknown, recorded vibration response of the screen fabric of the screening machine to be monitored.

It is expedient to train the adaptive algorithm with vibration responses from one or several comparative screen fabrics which are subject to an impact by a material supply of bulk solids, in particular a material supply with a constant or fluctuating amount and/or grain size of the material to be screened. This offers the advantage that a screen fabric can be characterized for different material supplies, wherein the detection of the state of the screen fabric will work despite varying material supplies. Advantageously, the adaptive algorithm can also be trained with vibration responses from one or several comparative screen fabrics which are not subject to any impact by a material supply of bulk solids.

It is advantageous if the adaptive algorithm is related to previous vibration responses of the screen fabric recorded by the vibration sensor. In this case, the comparative screen fabric is the screen fabric of the screening machine itself which is to be monitored. By the reference to previous vibration responses of the screen fabric, the adaptive algorithm can be trained before it will evaluate further vibration responses of a screen fabric and will characterize them for the subsequent detection. Consequently, the characterization diversity of states of the screen fabric can be further increased. Moreover, it is also possible to markedly reduce the time of training of the system by the previous, recorded vibration responses. Expediently, the training of the adaptive algorithm with the previous, recorded vibration responses is completed, which means that after the conclusion of the training the algorithm will not continue learning with each further characterization of a vibration response. Preferably, the time of training amounts to not more than a few minutes.

The configuration described in the foregoing paragraph is particularly advantageous for the so-called unsupervised learning.

Expediently, the adaptive algorithm is based on unsupervised learning. It is favorable to characterize vibration responses by means of an adaptive algorithm which is based on unsupervised learning.

In the unsupervised learning the characterization of the recorded vibration response is carried out by the algorithm with the aid of data originating from vibration responses of the screen fabric of the screening machine to be monitored which were previously recorded by the vibration sensor.

In case of the unsupervised learning, the training of the algorithm can be continued during operation of the screening machine to be monitored. Thus, expediently, the training can be carried out by the comparison of already characterized vibration responses of the screen fabric of the screening machine to be monitored which were previously recorded by the vibration sensor. Thus, an adaptation of the adaptive algorithm, in particular of the artificial neural network, by recurring patterns or regularities of the recorded vibration responses is possible. Similarities of the different vibration responses can serve as a basis for the adaptation of weighting factors in the neural network. Recognizable deviations in the recorded vibration response from the initially recognized patterns or regularities can be characterized as changed states of the screen fabric.

Expediently, the adaptive algorithm is based on semi-supervised learning. It is favorable to characterize vibration responses by means of an adaptive algorithm which is based on semi-supervised learning.

Semi-supervised learning is a combination of supervised and unsupervised learning. Thus, the adaptive algorithm, in particular the artificial neural network, can at first be trained by means of known error signatures in vibration responses of one or several comparative screen fabrics, and subsequently the training can be continued by means of previous vibration responses of the screen fabric of the screening machine to be monitored which were recorded by the vibration sensor.

Furthermore, it is expedient to base the learning of the adaptive algorithm on selected error signatures in previous, recorded vibration responses. These can enable the algorithm to automatically determine representative or essential features of the input vibration responses. Thereby patterns or regularities of vibration responses can be traced back on the basis of the input previous vibration responses and can thus be mapped onto a finite number of parameters. This can advantageously lead to the fact that, after input of the previous vibration responses together with error signatures, the algorithm will behave robust with respect to other (clearly) deviating vibration responses, in particular with respect to vibration responses which are subject to a strong statistic noise, for instance caused by external interfering influences.

Preferably, the adaptive algorithm comprises at least one of the following types of artificial neural networks: a deep Boltzmann machine, a convolutional neural network, a Siamese neural network, or a network on the basis of the learning vector quantization.

For the mentioned types of artificial neural networks, patterns or regularities of one or several recorded vibration responses can be mapped particularly quickly onto a finite number of robust parameters.

As already mentioned above, it is favorable if the inventive system for monitoring a screening machine furthermore comprises an excitation device which is configured to impress a vibration to the screen fabric of the screening machine.

Furthermore, it is also favorable if the excitation device comprises a ball cleaning device and/or an ultrasonic device. Particularly preferably, a ball cleaning device is adapted such that a plurality of balls will be caused to bounce from below against the screen fabric. Thereby a chaotic vibration can be impressed to the screen fabric. Expediently, said chaotic vibration covers a broad vibration spectrum. Thus, such a chaotic vibration can be regarded as a broadband vibration.

The ultrasonic device is configured such that it can impress an ultrasonic vibration to the screen fabric. In the high-frequency vibration spectrum, for instance slight changes in the state of the screen fabric can be recognized much better. Expediently, the excitation device is a piezoelectric actuator. This allows that various excitation frequencies or excitation amplitudes can be generated very easily.

According to the invention it is, however, also possible that a vibration is impressed to the screen fabric by a motion of the screening machine. In this case, the excitation device is configured such that it effects a motion of the screening machine which will vibrate the screen fabric. Expediently, the effectuated motion is a tumbling motion and/or a vibration.

Furthermore, it is also possible that the vibration is impressed to the screen fabric by the falling of the bulk solids onto the screen fabric. In this case, the excitation device is further configured such that it will distribute bulk solids on the screen fabric.

Advantageously, the excitation device is configured to impress a broadband vibration spectrum to the screen fabric of the screening machine. This has the advantage that various defects located at the screen fabric will be excited with their respective natural frequency/frequencies, also by taking into account external interfering influences. The excitation of said normal frequency/frequencies can cause clearly recognizable deviations of the recorded vibration responses from that of the normal state of the screen fabric. Said deviations then render possible a reliable detection of states of the screen fabric or the classification into further states or classes of states. Accordingly, vibration responses of a defective screen fabric can be clearly distinguished from vibration responses of an intact screen fabric or from vibration responses affected by other interfering influences. Depending on the number, the localization and the degree of defects or imperfections in the screen fabric, also different resonance frequencies of the screen fabric will appear. The larger the broadband of the impressed vibration spectrum is, the higher consequently also the likelihood will be that defects and/or imperfections will be detected in the vibration response, as the vibration response will cover a frequency spectrum which is all the more diverse, the larger the broadband of the impressed vibration spectrum is. This is due to the fact that, by means of several resonance frequencies, from the sum of the broadband excitation the adaptive algorithm will recognize changes in states of the screen fabric better and can characterize vibration responses in a more differentiated manner.

Advantageously, the excitation device is configured to periodically impress a frequency spectrum to a screen fabric in order to sequentially excite different (resonance) frequencies of a vibration spectrum and to record a frequency response and/or a phase response of the screen fabric. The advantage is that in case of the presence of defects or other interfering influences a scanning of the possible resonance frequencies of the screen fabric and/or of the natural frequencies of the screen fabric is carried out, and, thus, a more differentiated detection of changes in the state at the screen fabric is possible than by the excitation with only one frequency or only few frequencies or by a steady broadband excitation.

It is also favorable if the characterization of the vibration response into the normal state and the error state is made by the adaptive algorithm. As already explained above, the normal state characterizes the screen fabric having no defect, and the error state characterizes the screen fabric having a defect. This enables an easy characterization and identification of intact or defective screen fabrics.

Preferably, the error state includes at least one defect from the following list: tears in the screen fabric; abrasion of the screen fabric; extensions, blindings or cloggings, or mesh expansions of the screen fabric; tears, abrasion, extensions, blindings or cloggings, or mesh expansions of the screen fabric not yet occurred, but already in the state of developing; tears, abrasion, extensions, blindings or cloggings, or mesh expansions of the screen fabric not yet fully developed, but recognizably developing and expanding. By the detection of the error states with the cited defects, a comprehensive characterization of possible defects of the screen fabric can be prepared. This allows for a particularly precise state detection of the screen fabric. Furthermore, due to the characterization of error states being already in the state of developing, in an advantageous manner faulty screen changes can already be detected prior to the occurrence of a distinctive screen tear, and the screen fabric can be replaced correspondingly in due time, without larger amounts of screen feed to be screened having to be dumped or having to be screened once again.

Furthermore, the characterization of the vibration response by the adaptive algorithm is independent of the age of the screen fabric which, typically, with increasing age will more likely tend to have defects, or in which, with increasing age, defects will more likely be looming, as the adaptive algorithm can be trained with already available signs of wear of an older fabric.

Furthermore, it is expedient if the error states include tears in the screen fabric which have a size between 1 and 10 mm, preferably already between 1 mm and 5 mm. Thereby, vibration responses can be characterized in a sufficiently precise manner, and the throughput of bulk solids of a coarser grain size and not conforming to specifications can be effectively reduced or prevented.

Advantageously, the signal processing device is furthermore configured to perform a Fourier analysis, especially in particular a Fast-Fourier analysis, a Wavelet analysis, or a Constant Q analysis of the vibration response. Expediently, the cited analysis methods include the transformation of the vibration response by means of a Fourier, Wavelet or Constant Q transformation from the time domain into the frequency domain. Therefore, the transformed vibration response is a frequency-dependent function. By the detection of certain frequency components in the transformed vibration response, conclusions can be drawn with regard to the incidence of changes in the state of the screen fabric, since for instance defects like individual tears in a screen fabric will generate other components, in particular components of higher frequency, in the frequency spectrum than the intact screen fabric. Hence, the characterization of the vibration response by means of error signatures in the frequency domain can be more informative and, thus, of advantage.

Expediently, the signal processing device is configured to perform an autocorrelation method, or a cross-correlation method, or an inversion method, in particular a conjugate gradient inversion. With the aid of the cited methods, various vibration responses to be characterized can be correlated with each other in order to be able to characterize different states of the screen fabric in a more differentiated manner on the basis of said vibration responses.

Advantageously, the vibration sensor is implemented as an airborne sound sensor which can be arranged above or below the screen fabric or in the surroundings of the screen fabric. The vibration sensor can also be implemented as a structure-borne sound sensor which can be arranged at the screen fabric or at a screen body of the screening machine. Normally, vibrations of the screen fabric are in part heavily damped by the screen fabric during the material supply of bulk solids. By said preferred and combinable arrangements of the vibration sensors there will, however, be circumvented exactly the just mentioned damping effects, and, consequently, vibration responses of a particularly high-quality will be obtained which are ideally suited for an evaluation. It is expedient to use at least one triaxial and/or one uniaxial sensor, preferably two triaxial sensors, particularly preferably one uniaxial sensor, per screen fabric for the recording of the vibration responses.

Advantageously, the vibration sensor is configured to obtain the vibration response of the screen fabric from of a recorded vibration by means of a time interval filtering, an amplitude filtering, or a frequency filtering. This enables the filtering out of interfering signals which differ with respect to time interval, amplitude domain or frequency domain from the vibration response of the screen fabric.

Advantageously, the screen fabric has a mesh size of less than 5 mm, preferably of less than 1 mm, particularly preferably of less than 100 μm. Thereby the bulk solids can be fractionated from a coarse grain size up to a fine grain size.

Preferably, the impressed vibration is a sound vibration, particularly preferably a structure-borne sound vibration. It spreads well in the screen fabric and, thus, allows for a clear recognition of changes in the state of the screen fabric. Particularly preferably, the impressed vibration is an ultrasonic vibration. When an ultrasonic vibration is impressed to the screen fabric, due to the high frequencies of the impressed vibration, changes of the screen fabric in its vibration responses will stand out particularly clearly from vibration responses of the unchanged state.

According to a further aspect of the invention, a screening machine is provided which comprises a screen body, a screen fabric and a system for monitoring the screening machine according to the first aspect of the invention, as described above.

It is also possible that the screening machine comprises several screen bodies.

Advantageously, the screening machine according to the invention comprises a screen frame within which the screen fabric is clamped or on which the screen fabric is stretched. The screen frame can be arranged either internally to the screen body or externally to the screen body. By the arrangement of the components of the screening machine together with the screen frame, in case of a defect or a wear the screen fabric can be replaced quite easily. After a replacement of the screen fabric and the screen frame, advantageously the adaptive algorithm can further be trained anew once again. Hence, it is for instance possible to also take into account production-related variations of the screen tension. It is, however, also possible to clamp the screen fabric into the screen body. It is expedient if the screen fabric is clamped directly into the screen body without having to use one or several screen frames. The tension of the screen fabric will then be generated by appropriate fixing devices which are attached at the screen body.

Moreover, it is advantageous if the screening machine comprises a segmented screen fabric. A segmented screen fabric comprises several one-piece screen fabrics attached at or deposited on individual, segment-like screen frames, wherein said screen fabrics can be arranged on one plane next to each other. Thereby, inter alia, the costs in case of a developed screen fabric defect are reduced, as the screen fabric can be replaced segment-wise.

Advantageously, the screening machine comprises further screen fabrics which, conveniently, are arranged one upon the other. By means of screen fabrics of different mesh sizes, the fractioning of the bulk solids can be carried out gradually from a coarse grain size to a fine grain size.

It is also expedient to use a screen fabric made of metal or synthetic material. In contrast to conventional systems for the detection of screen tears, with the system according to the invention a detection of defects in the screen fabric is possible in both cases, i.e., for screen fabrics made of metal or of synthetic material.

It is of advantage if the screening machine is a tumbler screening machine which is configured such that the screening process is carried out by a tumbling motion of the screen body. The screening process can be carried out in a tumbler screening machine by a tumbling motion of a screen body. The impression of a vibration to the screen fabric can practically be effected by said tumbling motion. The vibration response of the screen fabric, which will be characterized by means of the adaptive algorithm according to the invention, is related to said vibration. In this case, the system for monitoring the screening machine comprises an excitation device configured to cause a motion, particularly expediently a tumbling motion, of the screening machine, which motion will vibrate the screen fabric. It is, however, also possible that the screening machine additionally comprises an excitation device or a further excitation device which impresses a vibration to the screen fabric. Thereby, the vibration excitation can be supported so that, apart from the tear detection, also the screening function will be improved. It is also expedient if the screening machine is a vibration screening machine.

Expediently, the vibration sensor is arranged at the screen frame and/or at the screen body. This has the advantage that installation and maintenance work at the vibration sensors can be accomplished in an easy and secure manner.

Advantageously, the diameter of the screen fabric lies between 600 and 2900 mm.

According to another aspect, the invention refers to a method for monitoring a screening machine, wherein said method will be described in the following.

The inventive method for monitoring a screening machine comprises the following method steps:
recording a vibration response of a screen fabric of the screening machine;

and
characterizing the recorded vibration response by means of an adaptive algorithm which is based on methods of artificial intelligence and which is related to vibration responses of one or several competitive screen fabrics.

It is particularly preferred that the adaptive algorithm is related to vibration responses of a plurality of comparative screening fabrics.

Expediently, the method according to the invention further comprises the step of impressing a vibration to the screen fabric.

Particularly preferably, the characterizing of the recorded vibration response is performed with the aid of error signatures which are characteristic for deviations of the recorded vibration responses between a normal state of the screen fabric and an error state of the screen fabric, wherein the normal state characterizes the screen fabric having no defect, and the error state characterizes the screen fabric having a defect.

Preferably, the comparative screen fabrics comprise screen fabrics which are different from the screen fabric of the monitored screening machine.

Preferably, the adaptive algorithm is related to previous, recorded vibration responses of the screen fabric of the monitored screening machine.

Advantages of the inventive method and its embodiments as well as further expedient embodiments can be inferred correspondingly from the system according to the invention as described above.

According to a further aspect of the invention, a computer program for monitoring a screening machine is provided which is adapted to carry out the above-described method.

A preferred embodiment of the present invention will be explained in detail by reference to the drawing, wherein

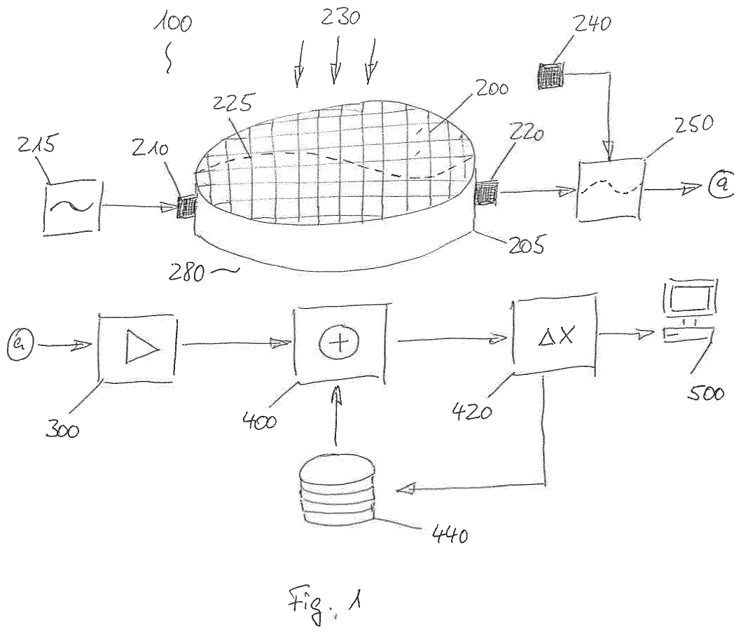

FIG. 1 shows a schematic view of a system according to the invention.

FIG. 1 shows a schematic view of an inventive system 100 for monitoring the screening machine 280. During intended use, the bulk solids 230 to be screened are poured onto the screen fabric 200 which is clamped into a screen body 205 and is part of the screening machine 280. It is, however, also possible that the screen fabric is clamped in or stretched on a screen frame which is coupled to the screen body 205. The screen body 205 performs a mechanical screening motion in the screening machine, by means of which the fine-grained faction is separated from the coarse-grained fraction by the fact that the fine-grained fraction falls through the meshes of the screen fabric 200 as completely as possible, whereas the coarse-grained fraction on the other hand remains as completely as possible on the screen fabric 200 and is discharged therefrom. In case of a tumbler screening machine the mechanical screening motion substantially is a circular tumbling motion. The mechanically excited screening process can be supported by the input of an additional vibration, in particular an ultrasonic vibration or a vibration generated by a ball cleaning device.

According to FIG. 1, an excitation device 210 which applies a vibration excitation 215 to the screen body 205 and, thus, impresses a vibration 225 to the screen fabric 200, is—in the present case merely by way of example—used not primarily for supporting of the screening process, but for the input of such an additional vibration for a better recognition/prediction of defects in the screen fabric. The excitation device can, however, also comprise the mechanism which moves the screening machine 280 or the screen body 205 and, thus, effects that a vibration is impressed on the screen fabric 200. For this purpose, a vibration response 250 of the screen fabric 200, which can differ in a characteristic manner from the vibration excitation 215, is recorded by at least one vibration sensor 220, 240, in particular an airborne sound sensor 240 and/or a structure-borne sound sensor 220, and is forwarded to a digital signal processing device 300 by means of which, apart from an analog gain, filtering and pre-processing, in particular an analog-digital conversion and a further digital processing, as for instance the filtering and suppression of disturbing noises, can be carried out. In this respect, the airborne sound sensor 240 can be arranged above or below the screen fabric 200 as well as next to the screen fabric 200. The vibration sensors 220, 240 can be arranged at different locations of the screen body 205, of the screen frame (not represented in FIG. 1), or at the screen fabric 200 itself.

The digitized and processed vibration response 250 will then be supplied to an evaluation system 400, 420, 440 of the signal processing device 300 which comprises an adaptive algorithm according to the methods of artificial intelligence which, for the characterization of the vibration response 250, comprises a comparison component 400 for comparing the processed vibration response 250 with stored error signatures in vibration responses of a signature and model database 440. Furthermore, the evaluation system also comprises a signature detection 420 which, on the basis of different difference values ΔX which remain after a comparison, can detect the state of the screen fabric or the nature and the extent of an occurred or impending defect, as for instance a screen tear or a screen extension, and can represent it by means of a representation component 500.

In this connection, the comparison component 400 and the signature detection 420 can adapt themselves to various screen fabrics, screen bodies, screen geometries and screen types and can compensate for normal continuous wear processes of the screen fabric as well as different consistencies of the bulk solids and can distinguish them from error signatures in vibration responses which are based on changes in the state of the screen fabric. By a continuous training of the adaptive algorithm, the signature detection 420 can also characterize new error signatures and can enter them into the signature database 420 so that the future detection performance of the evaluation system 400 can be improved. The signature detection 420 can comprise in particular statistical methods, learning methods, correlation methods, expert systems and neural networks which are particularly suitable for error signature detection. With the aid of the signature detection 420, the response time between the development of a screen defect and its recognition shall lie below 60 seconds, preferably below 30 seconds, and particularly preferably it shall be 10 seconds.

### LIST OF REFERENCE NUMERALS

100 system for monitoring a screening machine
200 screen fabric
205 screen body
210 excitation device
215 vibration excitation
220 vibration sensor, structure-borne sound sensor
225 impressed vibration
230 bulk solids
240 vibration sensor, airborne sound sensor
250 vibration response
280 screening machine
300 signal processing device
400 evaluation system of the signal processing device 300
420 signature detection of the evaluation system 400
440 signature database of the evaluation system 400
500 representation component

What is claimed is:

1. A system (100) for monitoring a screening machine (280), comprising:
a vibration sensor (220, 240) configured to record a vibration response (250) of a screen fabric (200) of the screening machine (210); and
a signal processing device (300, 400, 420, 440) for digitally processing and evaluating the vibration response (250),
characterized in that
the signal processing device (300, 400, 420, 440) comprises an adaptive algorithm which is based on the methods of artificial intelligence, is related to vibration responses of one or several comparative screen fabrics and is adapted to characterize the vibration response (250) recorded by the vibration sensor (220, 240).

2. The system (100) according to claim 1,
wherein the characterization of the recorded vibration response (250) is performed with the aid of error signatures which are characteristic for deviations of the recorded vibration responses (250) between a normal state of the screen fabric (200) and an error state of the screen fabric (200),
wherein the normal state characterizes the screen fabric (200) having no defect, and the error state characterizes the screen fabric (200) having a defect.

3. The system (100) according to claim 1, wherein the comparative screen fabrics comprise screen fabrics which are different from the screen fabric (200) of the screening machine (280) to be monitored.

4. The system (100) according to claim 1, wherein the adaptive algorithm is related to previous vibration responses (250) of the screen fabric (200) recorded by the vibration sensor (220, 240).

5. The system (100) according to claim 1 which further comprises an excitation device (210) which is configured to impress a vibration (225) to the screen fabric (200) of the screening machine (280).

6. The system (100) according to claim 5, wherein the excitation device (210) is configured to impress a broadband vibration spectrum to the screen fabric (200) of the screening machine (280).

7. The system (100) according to claim 5, wherein the excitation device (210) comprises a ball cleaning device and/or an ultrasonic device.

8. The system (100) according to claim 2, wherein the characterization of the vibration response (250) into the normal state and the error state is carried out by the adaptive algorithm.

9. The system (100) according to claim 2, wherein the error state comprises at least one defect from the following list: tears in the screen fabric (200); abrasion of the screen fabric (200); extensions, blindings or cloggings, or mesh expansions of the screen fabric (200); tears, abrasions, extensions, blindings or cloggings, or mesh expansions of the screen fabric (200) not yet occurred, but already in the state of developing; tears, abrasion, extensions, blindings or cloggings, or mesh expansions of the screen fabric (200) not yet fully developed, but recognizably developing and expanding.

10. The system (100) according to claim 1, wherein the signal processing device (300, 400, 420, 440) is furthermore configured to perform a Fourier analysis, a Wavelet analysis, or a Constant Q analysis of the vibration response (250).

11. The system (100) according to claim 1, wherein the vibration sensor is implemented as an airborne sound sensor (240) which can be arranged above or below the screen fabric (200) or in the surroundings of the screen fabric (200), or as a structure-borne sound sensor (220) which can be arranged at the screen fabric (200) or at a screen body (205) of the screening machine (280).

12. The system (100) according to claim 1, wherein the vibration sensor (220, 240) is configured to obtain the vibration response (250) of the screen fabric (200) from a recorded vibration by means of a time interval filtering, an amplitude filtering, or a frequency filtering.

13. A screening machine (280), comprising:
a screen body (205),
a screen fabric (200), and
a system (100) for monitoring the screening machine (280) according to claim 1.

14. The screening machine (280) according to claim 13, wherein the screening machine (280) is a tumbler screening machine which is configured such that the screening process is carried out by a tumbling motion of the screen body (205).

15. A method for monitoring a screening machine (280), said method comprising the following method steps:
recording a vibration response (250) of a screen fabric (200) of the screening machine (280);
and
characterizing the recorded vibration response (250) by means of an adaptive algorithm which is based on methods of artificial intelligence and is related to vibration responses (250) of one or several comparative screen fabrics.

16. The method according to claim 15,
wherein the characterizing of the recorded vibration response (250) is performed with the aid of error signatures which are characteristic for deviations of the recorded vibration response (250) between a normal state of the screen fabric (200) and an error state of the screen fabric (200),
wherein the normal state characterizes the screen fabric (200) not having any defect, and the error state characterizes the screen fabric (200) having a defect.

17. The method according to claim 15, wherein the comparative screen fabrics comprise screen fabrics which are different from the screen fabric (200) of the monitored screening machine (280).

18. The method according to claim 15, wherein the adaptive algorithm is related to previous, recorded vibration responses (250) of the screen fabric (200).

19. A computer program for monitoring a screening machine (280) which is adapted to carry out the method according to claim 15.
